(19) United States
(12) Patent Application Publication
(10) Pub. No.: US 2002/0126110 A1
(43) Pub. Date: Sep. 12, 2002

(54) Flip display screen and methods of using same

(76) Inventor: Julian Bowron, Toronto (CA)

Correspondence Address: David J. Heller, c/o Ridout & Maybee LLP, Suite 2400, One Queen Street East, Toronto, ON, M5C 3B1, CA

(21) Appl. No.: 10/075,556

(22) Filed: Feb. 15, 2002

Related U.S. Application Data
(60) Provisional application No. 60/268,708, filed on Feb. 15, 2001.

(51) Int. Cl. G09G 5/00

(52) U.S. Cl. 345/204

(57) ABSTRACT

An adjustable display screen system has: (a) a body; (b) a display screen on the body; (c) a stand pivotably connected to the body, the body pivotable from a first position at which the screen is viewable from a first side to a second position at which the screen is viewable from a second side substantially opposite the first side; (d) a data processor for projecting a first image on the screen; and (e) a control in communication with the data processor; wherein upon actuating the control the data processor projects a second image on the screen, and the second image is inverted in relation to the first image. A display screen system brake comprises a lever attached to a handle on the display screen system, the lever releasably engaged with the disk in an interference or friction fit, wherein upon actuating the handle the member is disengaged from the disk. A method for reversibly converting a customer service station from a self service station to a full service station is also taught.

### CROSS-REFERENCE

This patent claims priority from U.S. application Ser. No. 60/268,708 filed Feb. 15, 2001, entitled Flip Display Screen and Methods of Using Same

### FIELD OF THE INVENTION

The invention relates to display screens and methods for using display screens.

### BACKGROUND OF THE INVENTION

Many businesses and games use computer systems which include a display screen, such as a cathode ray tube (CRT), liquid crystal displays, plasma displays, projectors or the like. However, the conventional display device is designed and installed to allow only a single operator to exclusively refer to its screen and perform various processes. When two parties meet and have discussions which are related to information on a display screen, for example, at a bank teller station or a fast food restaurant station, it is desired and conventional that they are face to face with the display screen between them. In such transactions, conventional display devices are inadequate, in that they can only be viewed by one of the parties. Conventional display devices are also inadequate in that they are not capable of being readily converted from a self service mode to a full service mode.

U.S. Pat. No. 5,329,289 to Sakamoto et al. and U.S. Pat. No. 5,189,404 to Masimo et al. teach monitors which may be rotated 90° with a corresponding opposite rotation of the image on the screen, such that the vertical and horizontal orientations can be interchanged.

U.S. Pat. No. 4,814,759 to Gombrich et al. teaches a computer screen which may be rotated in various ways. At FIG. 2 the paragraph bridging columns 3 and 4, Gombrich contemplates that the video screen may be either faced outwards for use, or faced inwards towards a wall mounted housing for non-use.

U.S. Pat. No. 5,737,354 to Kawamura, U.S. Pat. No. 5,986,634 to Alioshin and U.S. Pat. No. 6,137,468 to Martinez each teach a laptop or portable display screen which can be rotated from a first orientation to a second orientation, including various means for simultaneously rotating the image on the screen such that the image on the screen remains upright in relation to horizontal.

However, none of these patents teach apparatus or methods for orienting a computer screen mounted such that it may be alternately viewed by two parties meeting face to face, with the screen between them.

In an attempt to meet this need, U.S. Pat. No. 5,926,154 to Hirono et al. teaches left and right deflection holograms located in a counter top display screen, such that a first party will view one image from the screen while a second image will be directed to a second party who is opposite the first party. This apparatus is expensive, consumes the preponderance of the central desktop space (which may be required for other transaction purposes), and must be built integral to the desk.

None of the above described apparatus are useful where it is desirable to have both parties capable of inputting information into or viewing a non-portable monitor. None of the above described apparatus are useful where it is desirable to readily convert a non-portable display monitor from input accessible on one side of the monitor to input accessible from the opposite side of the monitor.

Accordingly, there is a need for a versatile, inexpensive apparatus or method for allowing two persons meeting over a desk or counter top to each view one display screen. Furthermore, there is a need for a versatile, inexpensive apparatus or method for allowing a non-portable monitor to be readily converted from being accessible from one side of the desk or counter to accessible from the opposite side of the desk or counter top (e.g. readily convertible from a self service mode to a full service mode).

### SUMMARY OF THE INVENTION

The present invention provides a stand attached to a screen, wherein the screen can be viewed by a first party in one position, and then by a second party opposite the first party when the screen is rotated to a second position.

In accordance with this aspect of the present invention, there is provided an adjustable display screen system comprising: (a) a body; (b) a display screen on the body; and (c) a stand connected to the body and pivotable in relation to the body about an axis, the body pivotable from a first position at which the screen is viewable from a first side to a second position at which the screen is viewable from a second side opposite the first side.

In another embodiment, the invention teaches an adjustable display screen system comprising: (a) a display screen rotatable to face either a first side or a second side substantially opposite the first side; and (b) a control for setting images displayed on the display screen to either a first format or a second format; wherein the first format corresponds to the first side and the second format corresponds to the second side.

In a further embodiment, the invention teaches an adjustable display screen system comprising: (a) a body; (b) a display screen on the body; (c) a stand pivotably connected to the body, the body pivotable from a first position at which the screen is viewable from a first side to a second position at which the screen is viewable from a second side substantially opposite the first side; (d) a data processor for projecting a first image on the screen; and (e) a control in communication with the data processor; wherein upon actuating the control the data processor projects a second image on the screen, and the second image is inverted in relation to the first image.

The control may be actuated by pivoting the body from the first position to the second position. There can be a counter top between the first side and the second side. There may also be a receipt printer having an output channeling apparatus, the output channeling apparatus pivotable to channel printer output to either the first side or the second side.

The display screen system may have a releasable brake to releasably secure the display screen in a position. There may be a handle on the display screen system. The handle can be located on a first horizontal edge of the body. A second handle may be located on a second horizontal edge of the body, with the second horizontal edge is opposite the first horizontal edge.

The brake may comprise a lever attached to the handle, and a disk attached to the stand, wherein the lever is releasably engaged with the disk in an interference or friction fit, wherein upon actuating the handle the lever is disengaged from the disk. The brake may comprise a lever attached to both the handle and the second handle, and a disk attached to the stand, wherein the lever is releasably engaged with the disk in an interference or friction fit, and wherein upon actuating either of the handle or the second handle the lever is disengaged from the disk.

A fulcrum/stop may be in contact with the lever at a position proximal to the handle and on the same side of the lever as the disk, with a second fulcrum/stop in contact with the lever at a position proximal to the second handle and on the same side of the lever as the disk, and an elastic member in contact with the lever and biasing the lever towards the disk. The braking system may be selected from the group consisting of: a toothed brake; a pad friction brake; a conical clutch brake; and a multi-leaf clutch brake.

The control may be selected from the group consisting of: a microswitch; a rotating brush; a reed switch; a mercury switch; a coil and magnet; a photocell and light source; and a Hall effect transistor, or other device that can produce or modify a signal which directly or through processing can serve to change the image on the screen or the functioning of the screen (e.g. from accepting touch screen input to not accepting input).

The stand may be pivotably connected to the body about a horizontal axis. The stand may be secured to a ceiling. In another embodiment, the stand may be secured to a wall.

In a further embodiment, the display screen system can include an electronic sign located proximal to the screen, wherein by actuating the control an image on the sign is changed to a second image on the sign.

The output channeling apparatus may be pivoted automatically upon actuation of the switch. In another embodiment, there may be a motor for flipping or rotating the display screen. The motor may be connected to an input apparatus and memory storage unit and configured to contain a preset desired positioning of the screen corresponding to one of the sides and/or corresponding to a height of a person who wishes to view the screen.

The invention also teaches a method for reversibly converting a customer service station from a self service station to a full service station or from a full service station to a self service station comprising: (a) flipping or rotating a display screen from a first position at which the screen is viewable from a first side to a second position at which the screen is viewable from a second side opposite the first side; and (b) actuating a control which changes an image on the display screen from a condition suitable for use by a customer service representative to a condition suitable for use by a customer. The method may use a display screen system of the invention. In an embodiment, the condition suitable for use by a customer representative may not allow input into the display screen system and the condition suitable for use by a customer representative may allow input into the display screen system.

The invention also teaches a display screen system comprising: (a) a body; (b) a display screen on the body; (c) a stand pivotably connected to the body; (d) a handle on the body; and (e) a releasable brake; wherein the brake comprises a lever attached to the handle, wherein the lever is releasably engaged with the disk in an interference or friction fit, and wherein upon actuating the handle the member is disengaged from the disk.

The invention further teaches a brake system for a display screen system, wherein the disk is a gear, and the lever engages with the gear by means of a roller attached to a tension hinge.

In embodiments, the display screens may rotate about an axis that is substantially horizontal. In other embodiments, the display screen systems may rotate about an axis that is substantially vertical.

The invention also teaches a display screen system having a first and second display monitor on a stand, the first and second display monitors are configured such that the first monitor may be viewed by a first person and the second monitor may be viewed by a second person standing substantially opposite the first person.

In another embodiment, the display screen may be held in a yolk. The brake may then be a friction lock located on the yolk.

The invention further teaches a display screen system having a stand and a stand extension, the stand extension configured to telescope in relation to the stand and the stand extension is attached to a display screen. The stand extension may be releasably secured to the stand by means of a pull handle on the stand, the pull handle configured to releasably engage a series of vertical receptors on the stand extension.

### BRIEF DESCRIPTION OF THE DRAWINGS

A detailed description of the embodiments of the present invention is provided herein with reference to the following drawings, in which:

FIG. 1 is a perspective view of two adjustable display screen systems according to the present invention.

FIG. 2 is a vertical sectional view showing a brake system of a display screen of FIG. 1.

FIG. 3 is a side view of an alternate embodiment of a brake system of the present invention.

FIG. 4 is a side view of an alternate embodiment of a brake system of the present invention.

FIG. 5 is a side view of an alternate embodiment of a brake system of the present invention.

FIG. 6 is a sectional front view of the brake system of FIG. 5.

FIG. 7 is a side view of an alternate embodiment of a brake system of the present invention.

FIG. 8 is a sectional front view of the brake system of FIG. 7.

FIG. 9 is a vertical sectional view showing a switch system of a display screen of FIG. 1.

FIG. 10 is a detail view of an alternate embodiment of a switch system of the present invention.

FIG. 11 is a detail view of an alternate embodiment of a switch system of the present invention.

FIG. 12 is a detail view of an alternate embodiment of a switch system of the present invention.

FIG. 13 is a detail view of an alternate embodiment of a switch system of the present invention.

FIG. 14 is a detail view of an alternate embodiment of a switch system of the present invention.

FIG. 15 is a detail view of an alternate embodiment of a switch system of the present invention.

FIG. 16 is a detail view of an alternate embodiment of a switch system of the present invention.

FIG. 17 is a perspective view of an alternate embodiment of a display screen of the present invention.

FIG. 18 is a perspective view of an alternate embodiment of a display screen of the present invention.

FIG. 19 is a front perspective view of an alternate embodiment of several display screen systems of the present invention.

FIG. 20 is a partially exploded rear perspective view of the display screen systems of the present invention.

FIG. 21 is a cut away rear perspective view of the display screen systems of FIG. 20.

FIG. 22 is a horizontal sectional view showing a brake system of a display screen of FIG. 20.

FIG. 23 is a vertical sectional view showing a brake system of a display screen of FIG. 20.

FIG. 24 is a cut away perspective view showing cable access in the knuckle of a display screen of FIG. 20.

FIG. 25 is a front perspective view of an alternate embodiment of a display screen of the present invention.

FIG. 26 is a side view of a display screen of FIG. 25.

FIG. 27 is a vertical sectional view showing a brake system of a display screen of FIG. 25.

FIG. 28 is a side view of an alternate embodiment of a display screen of the present invention.

FIG. 29 is a side view of an alternate embodiment of a display screen of the present invention.

FIG. 30 is a rear view of a display screen of FIG. 29.

FIG. 31 is a side view of an alternate embodiment of a display screen of the present invention.

FIG. 32 is a vertical sectional view of a display screen of FIG. 31.

### DETAILED DESCRIPTION OF EMBODIMENTS

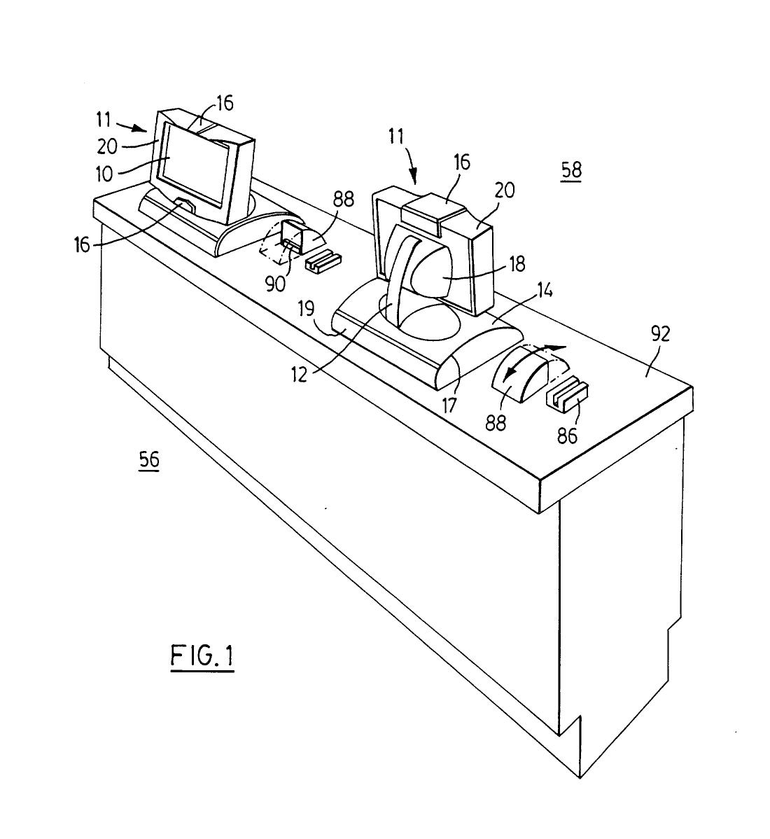

Referring to FIG. 1, there is illustrated two display screen systems. The left (distant) display screen system is oriented such that screen 10 is visible from a first side 56 of counter 92, while the right (proximal) display screen system is oriented such that the screen is visible from a second side 58 of counter 92. Monitor 11 includes an input device. For example, screen 10 may be a touch screen. Other input devices known in the art may also be provided with or integral to screen 10. Examples of input devices (not shown) include keyboards, key pads, mouse pads, track balls, touch pads, infrared or laser light, optical tracking, stereo comparison screens, or other input devices.

As seen in FIG. 1, the display screen system includes a monitor 11. The monitor has a screen 10, and a frame 20 surrounding and containing the screen 10. Frame 20 is secured to stand 12. Stand 12, in turn, is secured to base 14. Base 14 can house a central processing unit or other computer equipment. Alternatively, the central processing unit may be located elsewhere and in communication with the display screen by wires or by wireless means known in the art. Base 14 has a cable cover 19 and ventilation openings 17 to prevent overheating of the computer.

As seen in FIG. 1, monitor 11 is suitable for placement on counter 92, and body 18 may be flipped over such that screen 10 can be viewed by a first party in one position (side 56), and then by a second party on the opposite side 58 of the counter when the screen 10 is flipped to a second position.

Other elements of the display screen system include a card reader 86 and a printer output 90. Card reader 86 is a two ended card swipe, suitable for reading credit cards, debit cards, air miles cards and the like. Card reader 86 is suitable for use from either side of the counter 92. Alternately, dip card readers or slide card readers can be provided. Optionally, two card readers can be provided, one for each side of the counter.

Printer output 90 has a printer cover 88 which is pivotable. Printer cover 88 serves to direct paper issued from printer output 90 towards first side 56 or, when printer cover 88 is pivoted into the alternate position, towards second side 58. Alternatively the entire printer can be configured to be reversibly rotated from one side to the other. This rotation or pivoting can be automatic and can be actuated by the switches and controls discussed herein. Optionally, two printers can be provided, one at each side of the counter.

The display screen 10 can be reversibly oriented from facing first side 56 to second side 58 when handle 16 is depressed. It will be appreciated that handle 16 may be a switch, button, or other actuating means, and may be located at almost any part of monitor 11, so long as it is in contact, either directly or indirectly, with the braking system of the present invention. It will also be appreciated that monitor 11 can be reversibly flipped from a first position to a second position without the need for a brake system.

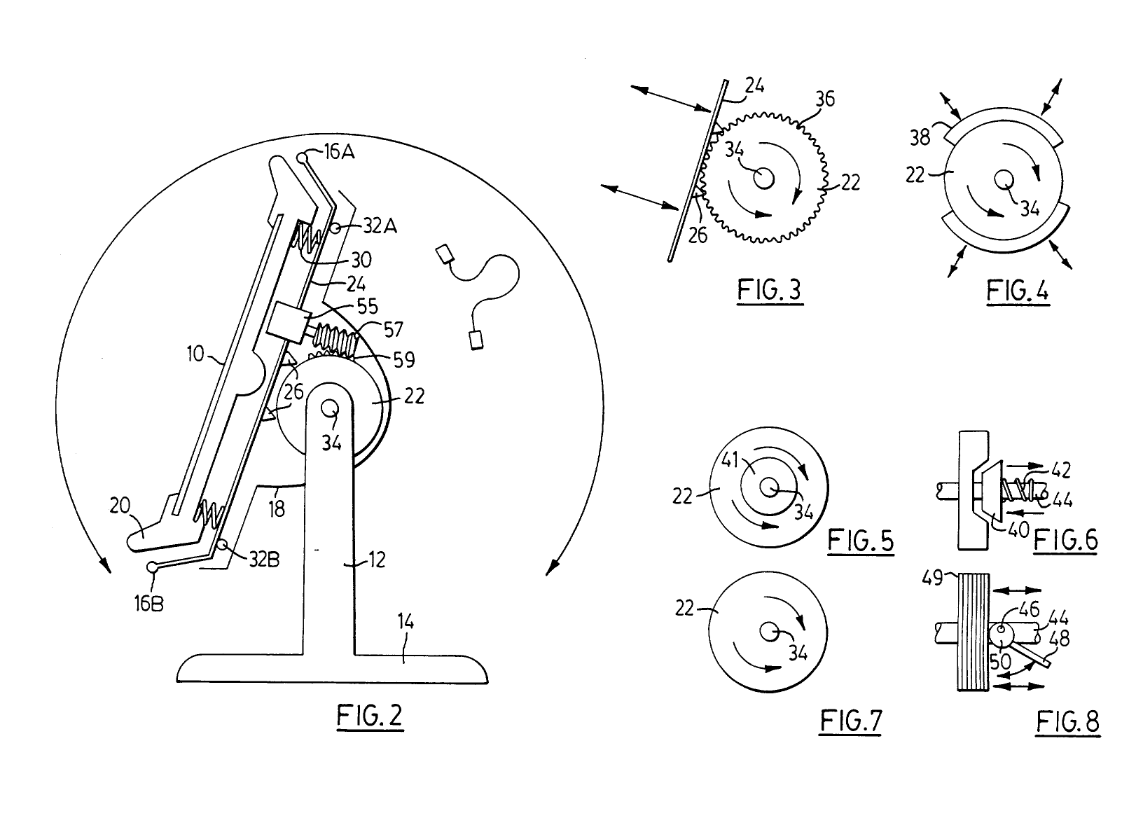

Turning now to FIG. 2, the brake system has handles 16 at both the top and bottom of the monitor frame 20. Upon depressing upper handle 16A, lever 24 rotates around fulcrum/stop 32B, thus moving projection 26 away from disk 22. Body 18 and stand 12 are secured to axis pin 34 such that stand 12 is pivotable in relation to body 18. Disk 22 is fixed to stand 12. When handle 16 is actuated and projection 26 release disk 22, body 18 is thus free to pivot in relation to stand 12. When handle 16 is released, projection 26 engage disk 22 in a friction or interference fit, thus preventing body 18 from pivoting in relation to stand 12. While the braking system is illustrated with two projections 26, it will be appreciated that any of one projection, no projection, or more than two projections may be used.

Springs 30 ensure that lever 24, and thus, in turn, projection 26, are biased towards disk 22. Springs 30 may be replace with one or more other elastic bodies, or may be repositioned, so long as the elastic member biases projection 26 towards disk 22.

When upper handle 16A is depressed, fulcrum/stop 32B acts as a fulcrum for lever 24. When upper handle 16A is released, fulcrum/stop 32A acts as a stop for lever 24. Similarly, when lower handle 16B is depressed, fulcrum/stop 32A acts as a fulcrum for lever 24. When lower handle 16B is released, fulcrum/stop 32B acts as a stop for lever 24.

As shown in FIG. 2 to FIG. 8, the interference or friction fit of the braking system may be accomplished by various means. An option for the apparatus, shown in FIG. 2, is worm gear 57 that acts as a brake on gear 59, and which, when rotated flips the screen.

As another example, FIG. 3 shows a toothed brake having teeth 36 with can form an interference fit with projection 26. Either one tooth, or, as illustrated, multiple teeth may be used. Alternatively, disk 22 may be movable and act as a gear.

FIG. 4 shows a pad type friction brake wherein pad 38 engages disk 22 in a clamping or friction fit. FIGS. 5 and 6 show a conical clutch brake, wherein clutch member 40 on clutch arm 44 releasably engages indentation 41 in central in disk 22 with the assistance of clutch spring 42. FIGS. 7 and 8 depict a multi-leaf clutch in which disk 22 comprises a plurality of compressible leafs 49 which are releasably engaged by a clutch cam 50 which is pivotably attached to clutch arm 44 by clutch pin 46. Clutch cam 50 is offset from its center by clutch pin 46. Upon actuating clutch lever 48, clutch cam compresses or releases leafs 49. In alternate embodiments, not shown, the braking system may not have a locking brake, but may comprise an ongoing friction fit, capable of being overcome upon exerting a reasonable amount of force.

Returning to FIG. 2, optionally, a motor 55 is attached to the worm gear, and motor 55 can be activated by the switch devices discussed herein to automatically flip the display screen when the switch is actuated. Motor 55 can be connected to an input apparatus and memory storage unit and configured to contain preset desired positioning of the screen corresponding to the side the person is standing on and/or the height of the person who wishes to view the screen. Thus, by simply pressing a button, the motor rotates the screen into the desired position for viewing.

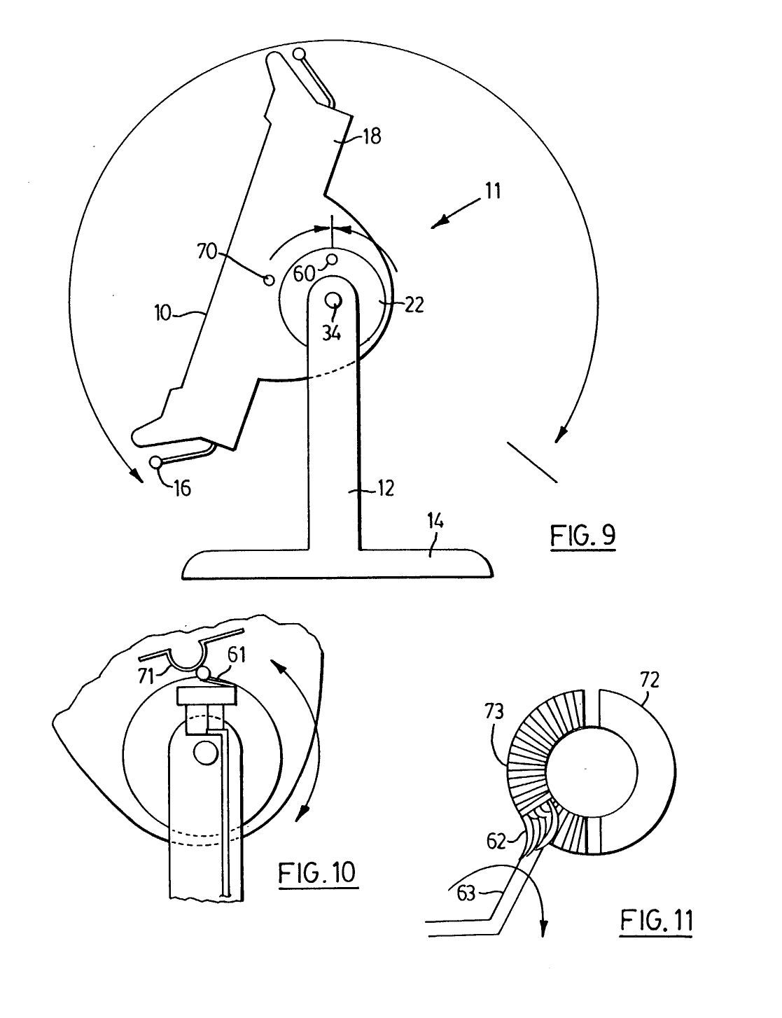

The invention includes a control for switching the images displayed on a screen from one format to another. In embodiments shown, this control switch is automatic, in that it is activated upon moving the body 18 from a first position to a second position. Automatic control switch 60 is shown in FIG. 9. Upon flipping body 18, actuator 70 on body 18 is brought into physical, electronic, or other contact with switch 60. Switch 60 then signals a central processing unit or other data processor to change the image on screen 10.

While FIG. 9 shows the switch actuator located on body 18 and the switch located on disk 22, it will be appreciated that the relative location of the switch and switch actuator may be reversed, or the switch and switch actuator may be positioned on other parts of the monitor 11, for example, on stand 12. In alternate embodiments, not shown, the images on the screen may be changed independently of flipping the screen. In other embodiments, the control switch is located remote from the display screen, such as in a manager's office, so that only the manager can convert the system from self service to full service.

Methods for interpreting and processing the signal and changing the image include, but are not limited to, software, video card drivers, hard wiring or video card or processor, CRT field coils, or LCD screen polarity. Several method for changing the image are taught in the prior art which is incorporated herein by reference, including U.S. Pat. No. 5,329,289 to Sakamoto et al, U.S. Pat. No. 5,189,404 to Masimo et al., U.S. Pat. No. 4,814,759 to Gombrich et al., U.S. Pat. No. 5,737,354 to Kawamura, U.S. Pat. No. 5,986,634 to Alioshin and U.S. Pat. No. 6,137,468 to Martinez

In a customer service setting, the image can be reversibly changed, for example, from a employee work screen to a self serve screen, or from a “station open” screen to a “station closed” screen, and/or the image may be flipped (i.e. rotated 180 degrees). In a game setting, the image can be reversibly changed, for example, from a first player screen to a second player screen.

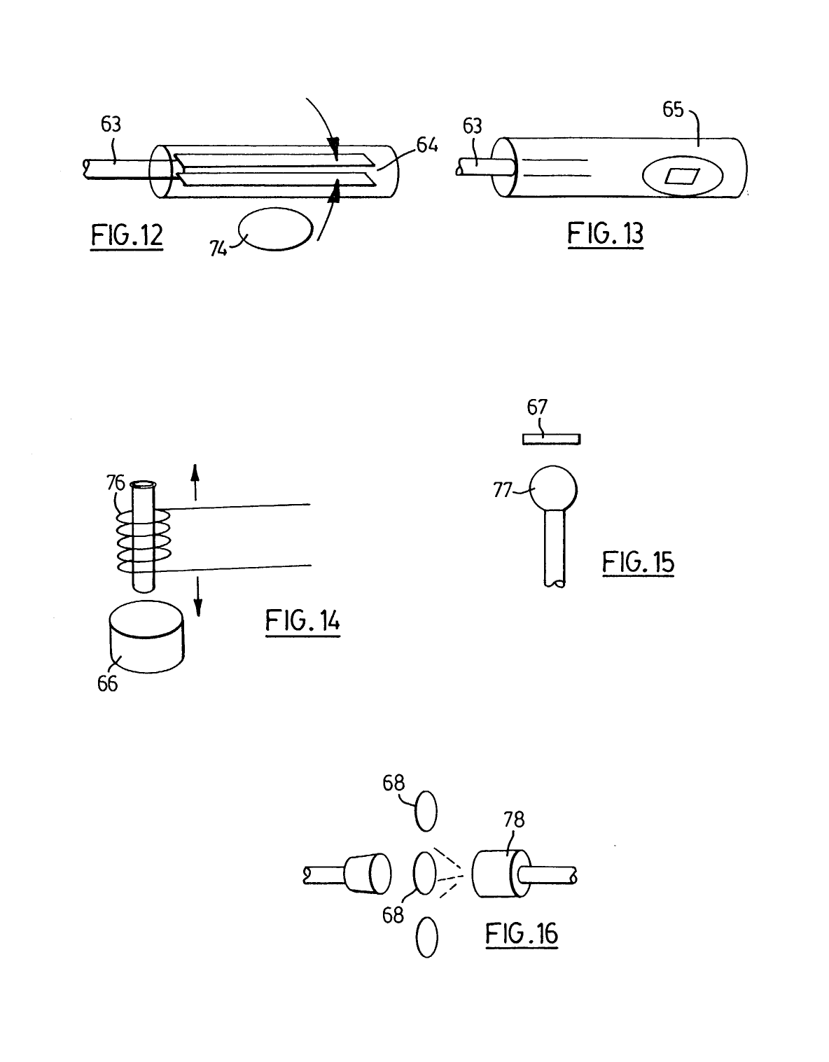

Various embodiments of control switch 60 are shown in FIGS. 10 to 16. FIG. 10 shows a microswitch 61 which is actuated by knob 71. Knob 71 may be a cam. FIG. 11 illustrates a rotating brush 62 attached to a circuit 63. Brush 62 contacts conductive portion 73, or, when rotated, non-conductive portion 72, and the circuit is thereby opened or closed. FIG. 12 shows a reed switch 64, which can be closed when in proximity with a reed actuator 74, such as a magnet, or opened when the reed switch is rotated away from the actuator. FIG. 13 shows a mercury switch 65. Depending on the rotation, and thus orientation of the mercury switch, mercury contained therein either flows to contact points that close a circuit or away from contact points thus interrupting the circuit. FIG. 14 shows a coil 76 and magnet 66. When the magnet is passed by the coil, a pulse of current is induced in the coil in a given direction. In an alternate embodiment, magnet 66 may be a core metal, and coil 76 acts as a metal detector. FIG. 15 shows a Hall effect transistor comprising magnet 67 which may be rotated proximal to or away from transistor 77, which is actuated by the presence or absence of the magnet. FIG. 16 illustrates a light source 78 which can be rotated relative to various photocells 68 to create an opto-electric switch.

It will be appreciated that other positional sensors, both contact and non contact may be used, such as a pendulum or other device that can produce or modify a signal which directly or through processing can serve to change the image on the screen or the functioning of the screen (e.g. from accepting touch screen input to not accepting input). Also, the control switch may be at a location remote from the display screen system (e.g. in a manager's office).

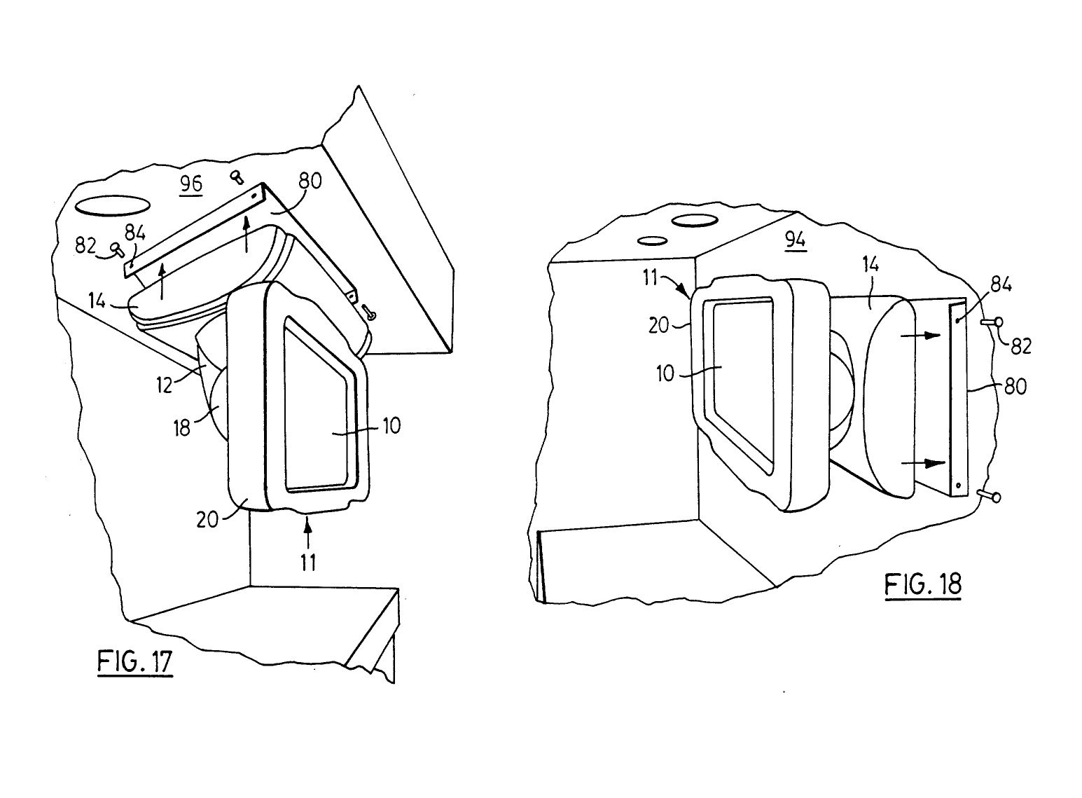

FIGS. 17 and 18 illustrate alternate positioning for monitor 11. In FIG. 17, monitor 11 is mounted to a ceiling or ceiling overhang 96 by means of a mounting shoe 80. Mounting shoe 80 is secured to the overhang 96. The base 14 of monitor 11 is then secured to mounting shoe 80 by means of fasteners 82 through apertures 84. In FIG. 18, monitor 11 is similarly mounted to a wall 94. In these embodiments, valuable counter top space can be maximized.

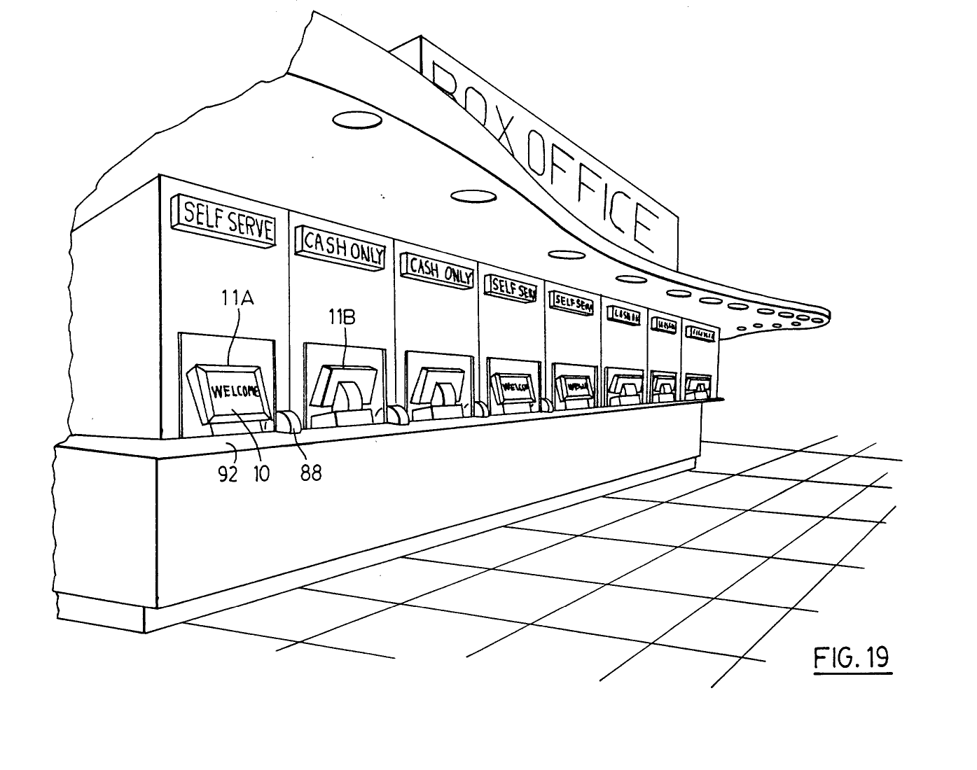

In a further embodiment shown in FIG. 19, the display screen system includes a sign 98 which is linked, either by wires or known wireless communication means to the switch 60 (not visible in FIG. 19). When the screen is flipped to face the customer side of the counter 92, as shown with the left (closest) monitor 11A, the image on screen 10 is suitable for self service and the sign 98 alerts customers that the monitor 11A is prepared for self service. When the screen is flipped to face the cashier's side of the counter 92, as shown with the next monitor 11B, the sign 98 alerts customers that monitor 11B is available for full service. In addition, printer cover 88 can be flipped to direct papers or tickets to either the customer or staff. The image change and the printer rotation can be accomplished automatically, upon actuation of the switch control discussed herein, or it can be accomplished though a switch or apparatus independent of the switch associated with the screen flip.

The present invention thus provides methods for conducting business. For example, the screen can be flipped to reversibly convert a staffed customer service station to a self service station. As a further example, converting the screen to a condition suitable for use by a customer representative can place the display screen system in a condition which does not allow input into the display screen system, while converting the screen to a condition suitable for use by a customer representative places the screen system in a condition which does allow input into the display screen system. All this can be achieved automatically using the switches and controls described above.

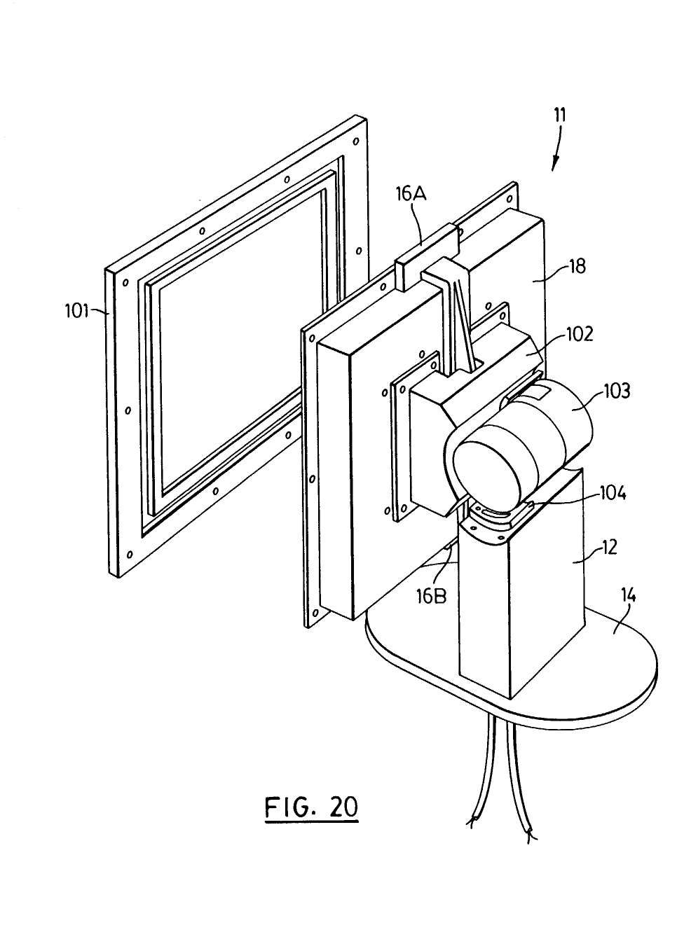

FIG. 20 is a partially exploded rear perspective view of the display screen systems of the present invention, showing face plate 101, body 18, lever base 102, knuckle 103, stand 12 and gasket 104 detached. Levers 16A and 16B extend into lever base 102. Stand 14 is configured to provide stability when flipping the monitor 11.

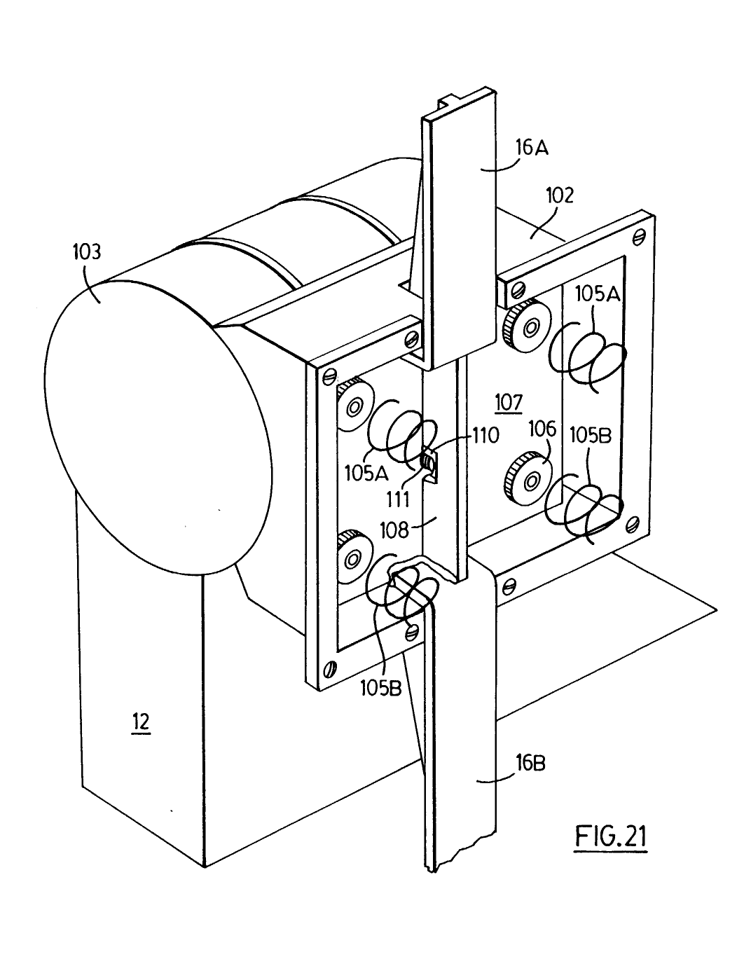

FIG. 21 is a cut away rear perspective view of the display screen systems of FIG. 20, showing the lever base 102, the knuckle 103, and portions of the stand 12 and lever arms 16A and 16B. Two springs 105A and two springs 105B are affixed to washers 106 on lever plate 107. Lever arms 16A and 16B are secured to lever plate 107. Lever plate 107 and lever arms 16A and 16B are also secured to arm plate 108, which is perpendicular to lever plate 107. At its center, on the side of the lever plate, arm plate 108 has a cut away 110 to accommodate a bolt 111.

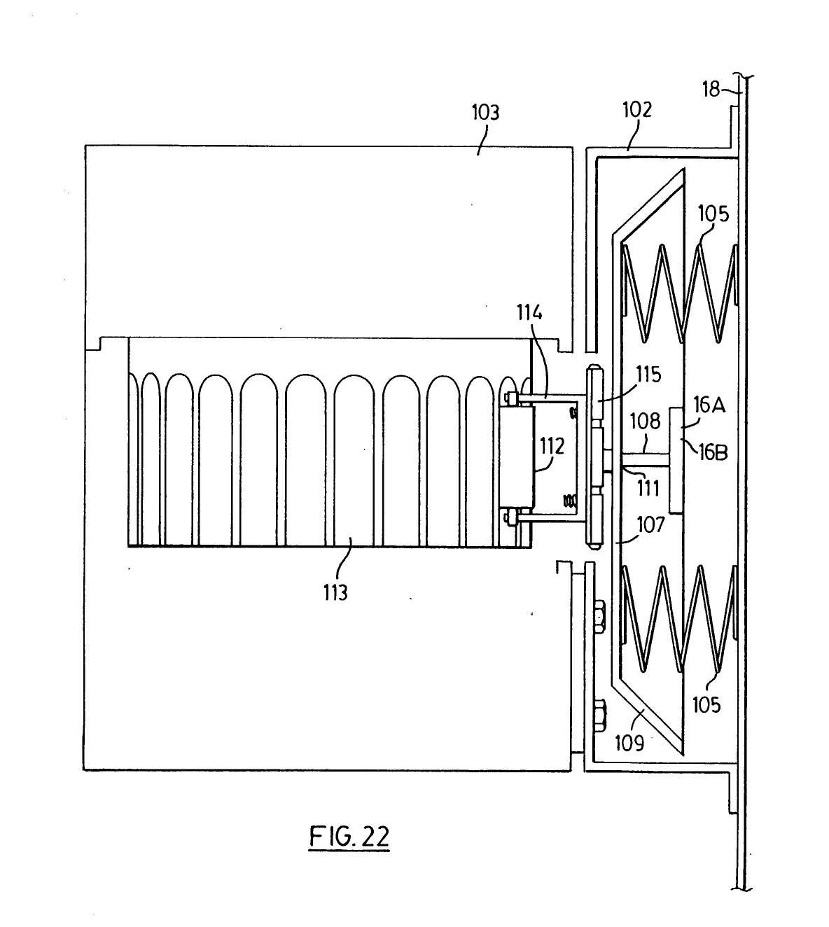

FIG. 22 is a horizontal sectional view showing a brake system of a display screen of FIG. 20. It should be noted that in FIG. 21, lever plate 107 has angular lever plate walls 109, which are not shown in FIG. 20. FIG. 22 shows the interaction between roller 112 and gear 113, which together act as a brake for the display screen.

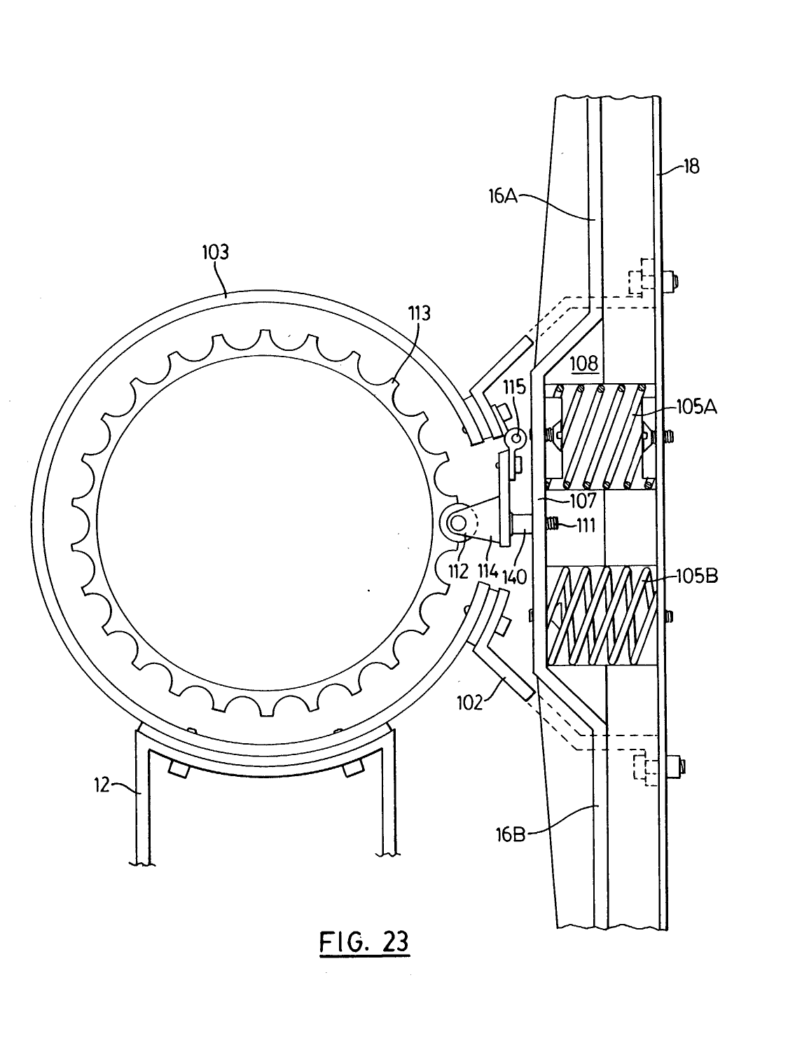

FIG. 23 is a vertical sectional view showing a brake system of a display screen of FIG. 20, showing further detail of the interaction between roller 112 and gear 113, which together act as a brake for the display screen. Depressing either of lever arms 16A or 16B pivots lever plate 107 around a pivot line located across one of the horizontally aligned pairs of springs 105A or 105B. This pivoting of the lever plate 107 moves bolt 111 away from gear 113. Thus, when lever arm 16A is depressed towards body 18, springs 105A are depressed by the lever arm, and springs 105B become a pivot point for lever plate 107. When lever arm 16B is depressed towards body 18, springs 105B is depressed by the lever arm, and springs 105A become a pivot point for lever plate 107. Alternatively, both lever arms 16A and 16B can be depressed towards body 18. Regardless, when one or both lever arms are depressed, lever plate 107 moves bolt 111 away from the knuckle 103. Bolt 111 is secured to a roller stop 140. Roller stop 140 prevents roller assembly 114, and thus roller 112 from moving away from gear 113, unless roller stop 140 is moved by depressing the lever arms. When roller stop 140 is so moved, roller assembly 114, which is secured to knuckle 103 by means of tension hinge 115, is able to move away from gear 113, and thus body 18 can rotate in relation to knuckle 103. When the lever arms are released, roller stop 140 again prevents roller assembly 114 and roller 112 from disengaging from gear 113, and thus the body 18 can not rotate. Spring 105A is shown in casing 116, while spring 105B is not in a casing.

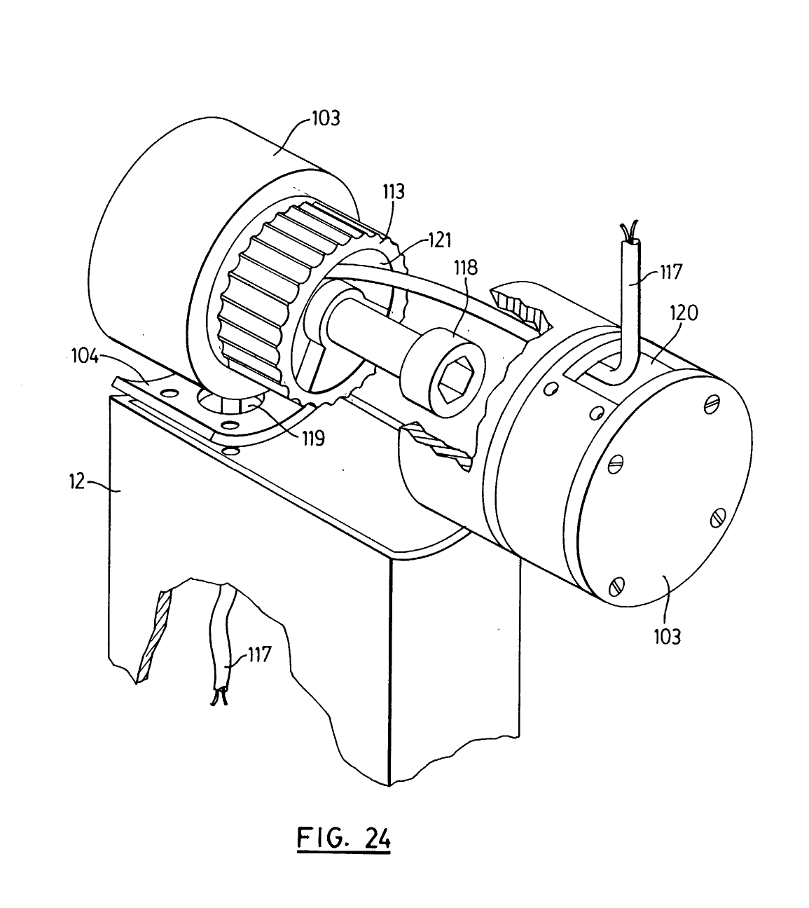

FIG. 24 is a cut away perspective view showing cable access in the knuckle of a display screen of FIG. 20, in which knuckle 103 has been separated to show interior detail. Gear 113 is attached to the knuckle 103 by a hex shoulder screw 118. Cable 117 projects through the hollow interior of stand 12, and continues upward through stand and gasket openings 119. Gear 113 is configured to provide gear opening 121 for the cable 117, which then proceeds on through knuckle opening 120, for attachment to the display screen 10 (not shown).

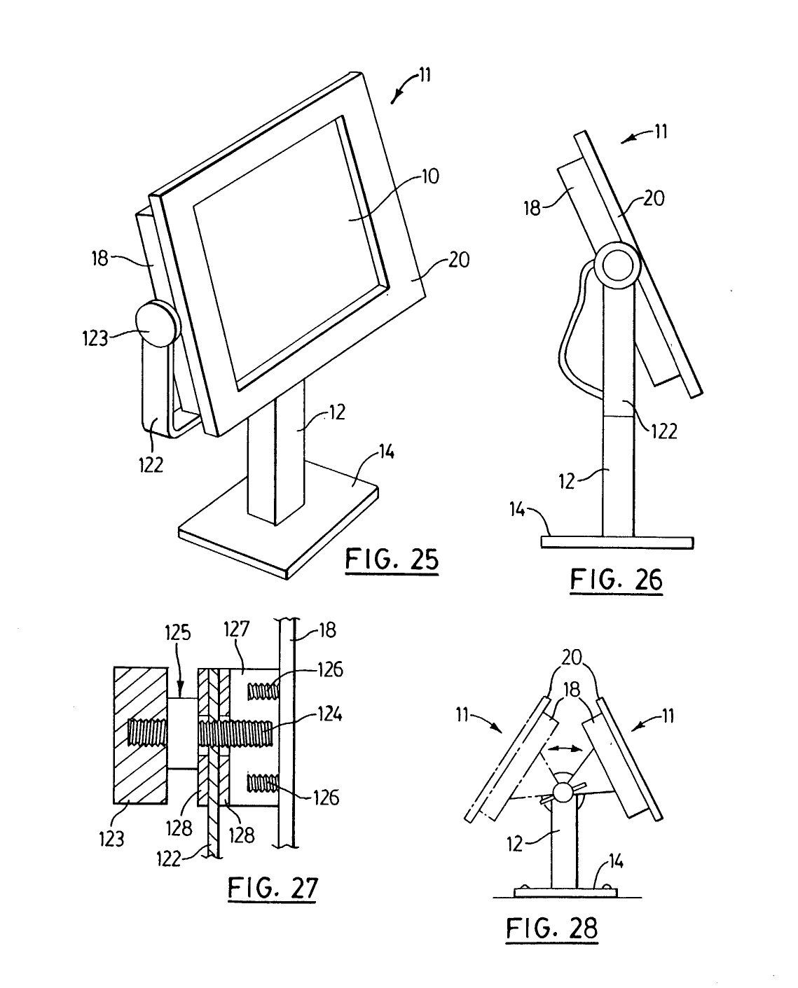

FIG. 25 is a front perspective view and FIG. 26 is a side view of an alternate embodiment of a display screen of the present invention. FIG. 28 is a vertical sectional view showing a brake system of a display screen of FIG. 27. In this embodiment, display screen 10 is attached to stand 12 by means of a yolk 122. Details of this attachment, and the braking means, are shown in FIG. 27. Screws 126 attach assembly 127 to the body 18 of the display screen. A screw 124 attaches a handle 123 to the assembly 127. Screw 124 proceeds through a stop 125 and yolk 122, which is sandwiched between two gaskets 128. Handle 123 is used to tighten and loosen the screw 124, as desired by the user. When screw 124 is tightened, the stop 125 and assembly 127 sandwich together and tighten gaskets 128 on yolk 122, creating a brake effect, and thus preventing the monitor 11 from rotating in relation to the yolk 122. When screw 124 is loosed, gaskets 128 are loosed off yolk 122, allowing the monitor 11 to rotate freely in relation to the yolk 122.

FIG. 28 is a side view of an alternate embodiment of a display screen of the present invention. In this embodiment, in place of a means for flipping a single monitor, two monitors 11 are attached to a stand 12. This embodiment is useful for simultaneous viewing of monitors by individuals spatially opposed to each other.

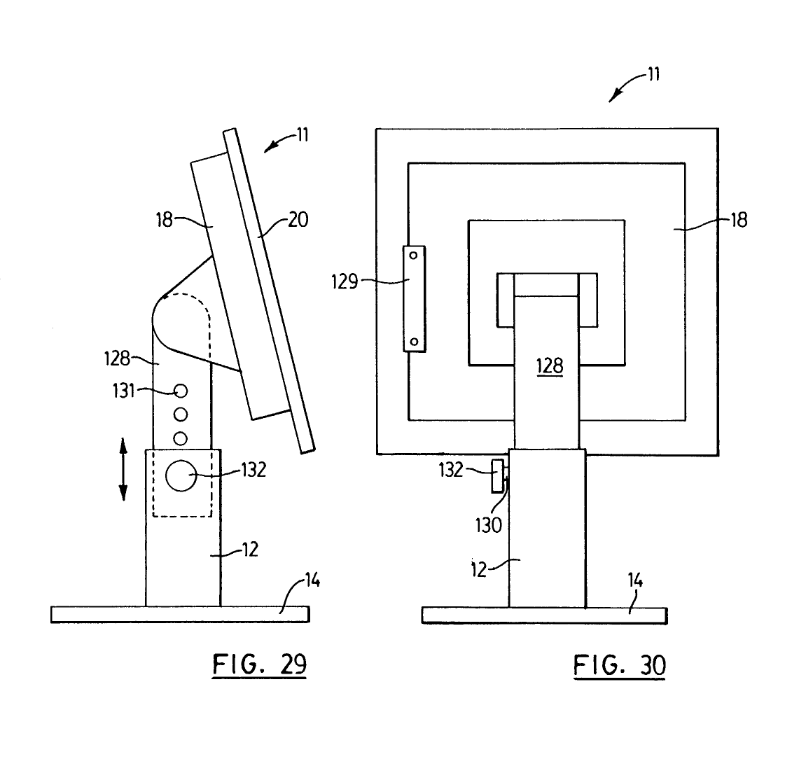

FIG. 29 is a side view of an alternate embodiment of a display screen of the present invention. FIG. 30 is a rear view of a display screen of FIG. 29. This embodiment allows for a user to raise and lower a monitor 11. Stand 12 has a stand extension 128 inserted therein. A pull 130 extends outwardly through a hole in the stand 12. Pull 130 has a handle 132. Extension 128 has a series of receptors 131 extending vertically along extension 128. Receptors 131 are configured to receive pull 130. When pull 130 is engaged in a receptor 131, extension 128 can not move relative to stand 12. When pull 130 is pulled outward from stand 12 by means of handle 132, pull 130 is disengaged from receptor 131, and extension 128 maybe moved freely upward or downward in relation to stand 12, thus raising or lowering monitor 11 as desired by the user. A monitor handle 129 is provided to assist the user in raising or lowering the monitor 11.

FIG. 31 is a side view of an alternate embodiment of a display screen of the present invention.

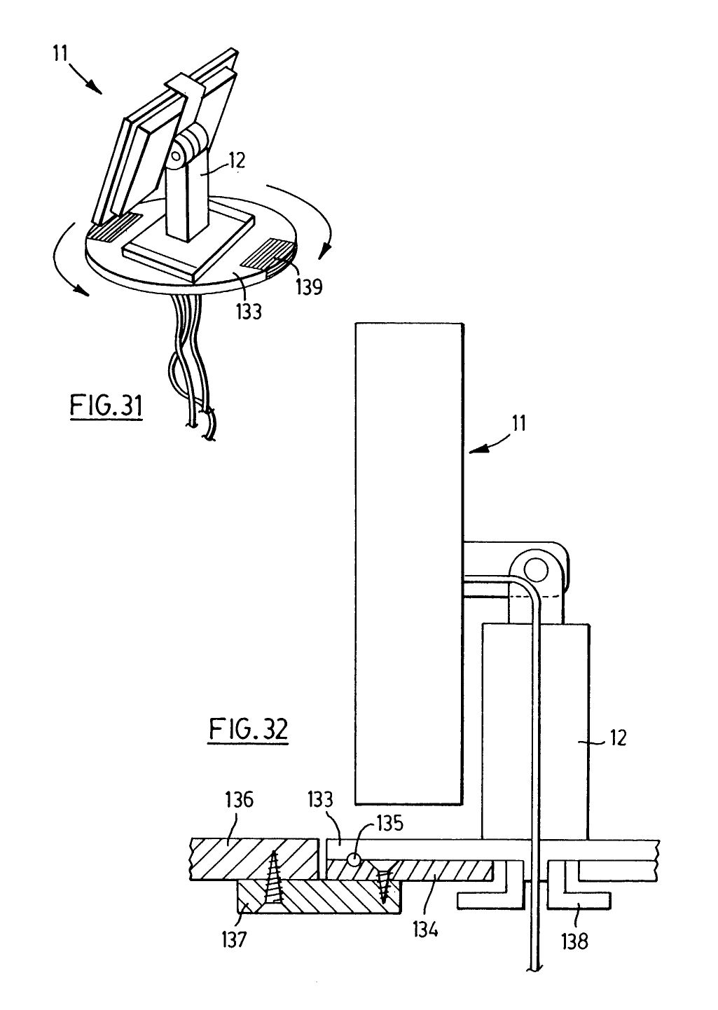

FIG. 32 is a vertical sectional view of a display screen of FIG. 31. In this embodiment, monitor 11 may be swivelled instead of flipped. Monitor 11 is attached to a swivel base 133 by means of stand 12. Swivel base 133 is secured to base 134 by means of flanges 138, but swivel base 133 remains rotatably free in relation to attaching base 134. Rollers 135, for example, ball bearings, maybe provided to facilitate rotation of swivel base 133 in relation to attaching base 134. Attaching base 134 is may be secured to a counter top 136 by means of an attaching piece 137. Handles 139 provide a grip for the user to more easily rotate the monitor 11.

Other variations and modifications are possible. All such modifications or variations are believed to be within the scope of the invention as defined by the claims appended hereto.

What is claimed is:

1. An adjustable display screen system comprising:
(a) a display screen rotatable to face either a first side or a second side substantially opposite said first side; and
(b) a control for setting images displayed on said display screen to either a first format or a second format;
wherein said first format corresponds to said first side and said second format corresponds to said second side.

2. A display screen system as claimed in claim 2, wherein said control is actuated by pivoting said body from said first position to said second position.

3. A display screen system as claimed claim 1, further comprising a counter top between said first side and said second side.

4. A display screen system as claimed in claim 1, further comprising a receipt printer having an output channeling apparatus, said output channeling apparatus pivotable to channel printer output to either said first side or said second side.

5. A display screen system as claimed in claim 1, further comprising a releasable brake to releasably secure said display screen in a position.

6. A display screen system as claimed in claim 1, further comprising a handle on said display screen system.

7. A display screen system as claimed in claim 6, wherein said handle is located on a first horizontal edge of said body.

8. A display screen system as claimed in claim 7, further comprising a second handle located on a second horizontal edge of said body, and said second horizontal edge is opposite said first horizontal edge.

9. A display screen system as claimed in claim 6, wherein said brake comprises a lever attached to said handle, and a disk attached to said stand, wherein said lever is releasably engaged with said disk in an interference or friction fit, and wherein upon actuating said handle said lever is disengaged from said disk.

10. A display screen system as claimed in 9, wherein said brake comprises a lever attached to said handle and a second handle, and a disk attached to said stand, wherein said lever is releasably engaged with said disk in an interference or friction fit, and wherein upon actuating either of said handle or said second handle said lever is disengaged from said disk.

11. A display screen system as claimed in claim 10, further comprising a fulcrum/stop in contact with said lever at a position proximal to said handle and on the same side of said lever as said disk, a second fulcrum/stop in contact with said lever at a position proximal to said second handle and on the same side of said lever as said disk, and an elastic member in contact with said lever and biasing said lever towards said disk.

12. A display screen system as claimed in claim 11, wherein said brake and said lever comprise a braking system, and said braking system is selected from the group consisting of: a toothed brake; a pad friction brake; a conical clutch brake; and a multi-leaf clutch brake.

13. A display screen system as claimed in claim 1, wherein said control is selected from the group consisting of: a microswitch; a rotating brush; a reed switch; a mercury switch; a coil and magnet; a photocell and light source; and a Hall effect transistor.

14. A display screen system as claimed in claim 1, wherein said stand is pivotably connected to said body about a horizontal axis.

15. A display screen system as claimed in claim 1, wherein said stand is secured to a ceiling.

16. A display screen system as claimed in claim 1, wherein said stand is secured to a wall.

17. A display screen system as claimed in claim 1, further comprising an electronic sign located proximal to said screen, and wherein by actuating said control an image on said sign is changed to a second image on said sign.

18. A display screen system as claimed in claim 4, wherein said output channeling apparatus is pivoted automatically upon actuation of said switch.

19. A display screen system as claimed in claim 1, further comprising a motor for flipping or rotating said display screen.

20. A display screen system as claimed in claim 19, wherein said motor is connected to an input apparatus and memory storage unit and said memory storage unit is configurable to contain a preset desired positioning of said screen corresponding to one of the said sides or corresponding to a height of a person who wishes to view said screen.

21. A method for reversibly converting a customer service station from a self service station to a fill service station or from a full service station to a self service station comprising:
(a) flipping or rotating a display screen from a first position at which said screen is viewable from a first side to a second position at which said screen is viewable from a second side opposite said first side; and
(b) actuating a control which changes said display screen from a condition suitable for use by a customer service representative to a condition suitable for use by a customer.

22. A method as claimed in claim 21, wherein said customer service station comprises said display screen system of claim 1.

23. A method as claimed in claim 22, wherein said condition suitable for use by a customer representative does not allow input into said display screen system and said condition suitable for use by a customer representative does allow input into said display screen system.

24. A display screen system having a first and second display monitor on a stand, said first and second display monitors are configured such that said first monitor may be viewed by a first person and said second monitor may be viewed by a second person standing substantially opposite said first person.

25. A display screen system as claimed in claim 5, wherein said display screen is held in a yolk.

26. A display screen system as claimed in claim 25, wherein said brake is a friction lock located on said yolk.
